(19) United States
(12) Patent Application Publication
(10) Pub. No.: US 2024/0262131 A1
(43) Pub. Date: Aug. 8, 2024

(54) PNEUMATIC TIRE WITH INTEGRATED ENVELOPE

(71) Applicants: SAMEER PANDA, Faridabad (IN); SMITIPARNA SATPATHY, Faridabad (IN)

(72) Inventors: SAMEER PANDA, Faridabad (IN); SMITIPARNA SATPATHY, Faridabad (IN)

(21) Appl. No.: 18/565,544

(22) PCT Filed: May 31, 2022
(86) PCT No.: PCT/IB2022/055083

§ 371 Date: Nov. 30, 2023

(30) Foreign Application Priority Data
May 31, 2021 (IN) 202111024298

(51) Int. Cl. B60C 9/00; B60C 1/00; B60C 5/00; B60C 5/14; B60C 15/05; B60C 19/12

(52) U.S. Cl. CPC B60C 9/00; B60C 1/00; B60C 5/004; B60C 5/14; B60C 19/12; B60C 15/05

(57) ABSTRACT

The present invention provides a pneumatic tire (100) with integrated envelope comprising, a tread (1), a belt system (2), and a tire casing (3), wherein said tire casing (3) comprises a side wall (4), a bead (5), a plurality of layer including but not limited to a carcass ply (6) acting as a top layer, an inner liner (7) acting as bottom layer and an envelope (8) that is sandwiched between said carcass ply (6) and the inner liner (7), said envelope (8) is injected with a fluid inside said tire casing (3) in which said tire casing (3) is pasted on said belt system (2) and said belt system (2) is pasted on said tread (1) in said pneumatic tire (100) and said side wall (4) protects said tire casing (3).

### FIELD OF THE INVENTION

The present invention relates to a pneumatic tire accommodating an envelope to improve its strength, durability and life. More particularly, the present invention relates to a tire comprising of a tire casing having an envelope for encapsulating a sealant and coolant, and also increasing the potency and verve of tire.

### BACKGROUND OF THE INVENTION

A tire is a ring shaped component that surrounds the wheel's rim to transfer the vehicle load from the axle through the wheel to the ground and to provide the traction. Most tires are pneumatically inflated that provides a flexible cushion to absorb shock. Tires consist of a tread and a body. The tread is the part of the tire that comes in contact with the road surface. It is a thick rubber to provide an appropriate level of traction that does not wear quickly. The body of tire has many components such as tire bead that contacts the rim on the wheel, the side wall that bridges between the tread and bead and plies that are made of rubber cords to provide the tensile strength to the tire.

The plies are nothing but several layers of different fabrics and determine the strength of the tire. Most tires have two plies, four plies, eight plies or more than that. The plies are placed in sensitive areas of the tire to limit the scrubbing against the wheel and serve the purpose of air valve for tubeless tires. As the number of ply increases in a tire, it becomes tougher and stiffer.

U.S. Pat. No. 3,989,083A discloses a tire for a racing vehicle characterized by multiple carcass plies in which both tension and shear stresses are shared equally by the carcass plies and cord reinforcements of the plies, this being accomplished by varying the pathways and end counts of the reinforcement cords from ply-to-ply and the gauge of the plies. The main drawback of the invention is that these plies bear load and sometimes if load is high, they may break the tire or creates cracks.

U.S. Pat. No. 3,406,733A discloses a bead for a pneumatic tire having a carcass of substantially radially-directed nonmetallic cords is provided with a bead wire around which the cords are folded and first and second layers of an elastomeric buffering composition. The elastomeric buffering composition is on opposite sides of the cords extending around the bead wire and envelops the cords in the vicinity of the bead wire. The composition has a modulus of elasticity in g/mm measured at 100% elongation not exceeding 0.8 of the modulus of elasticity in kg./mm. of the carcass cords measured under a load equaling one-tenth of their breaking load. The main drawback of the invention is that the carcass is provided with the bead which leads to the wastage of the material for carcass.

PT79180B discloses a method and apparatus for sealing a tire retreading envelope against a tire carcass for vulcanization of a new tread portion onto the carcass utilizing a rigid circular ring and a series of clamps on the ring for clamping the ring tightly onto the exterior of the tire carcass bead with the envelope sandwiched between the ring and bead. However, the envelope referred here is not a part of the tire instead used at manufacturing stage at the outer periphery and removed after manufacturing is complete. With a ring clamped onto each bead of the tire, air or other gases are prevented from passing when the envelope is evacuated and the tire goes through a vulcanization process. Centering pins are preferably included on the ring for engaging the bead and assuring that the ring is coaxial with the tire.

Moreover, the plies are pasted on the tread with the help of powder which leads to the crack in tire and reduces the life of the tire. Therefore, there is a need of a pneumatic tire with envelope which takes less or no load and ultimately increases the life of the tire.

### OBJECT OF THE INVENTION

The main object of the present invention is to provide a pneumatic tire equipped with an envelope with sealant, coolant and other viscous liquid in its tire to increase its strength, durability, life and auto heal in case of puncture, auto cool the said tire to prevent burst.

Another main object of the present invention is to provide a powder less pneumatic tire having an envelope that is integrated with an inner liner to improve the life span of the tire.

Yet another object of the present invention is to provide a pneumatic tire injected with a sealant inside its envelope to prevent the leakage of air/gas in tire at the time of puncture.

Still another object of the present invention is to provide a pneumatic tire having a tread, a belt system and a tire casing with an envelope to provide a powder less and strong tire.

### SUMMARY OF THE INVENTION

The present invention relates to a pneumatic tire accommodating an envelope to improve its strength, durability, life and prevent tire burst by decreasing localized over-heating, by providing coolant inside the envelope. More particularly, the present invention relates to a tire comprising of a tire casing having an envelope for encapsulating a sealant and also increasing the potency and verve of tire.

In a main embodiment, the present invention provides a pneumatic tire with integrated envelope comprising of a tread, a belt system and a tire casing. The tire casing is pasted on the belt system and said belt system is pasted on the tread and vulcanized together to form the structure of said tire. The tread is the outer layer of the tire that comes into direct contact with the road surface. The tire casing is the body of the tire and includes a side wall, a bead and a plurality of layers such as but not limited to carcass ply, an inner liner and an envelope, wherein the carcass ply is a top layer of tire casing pasted on the belt system of the tire to sustain load and absorbs shock subsequently attached to the inner liner forming the bottom layer of the tire casing pasted on the carcass ply to hold the air pressure inside the tire followed by an envelope forming the middle layer of the tire casing pasted on the inner liner of the tire. The envelope is a closed hollow body injected with a sealant and coolant to seal any leakage in the tire and prevent overheating respectively. The envelope either touches the sidewall of the tire or is placed within the sidewall of the tire. The belt system is placed on the top of the tire casing to provide stability to the tread.

In another embodiment, the present invention provides a pneumatic tire having a tread, a belt system and a tire casing. The tire casing is the body of the pneumatic tire comprises of a side wall, a bead and a plurality of layers such as but not limited to carcass ply, an inner liner and an envelope. The tire casing has plurality of layer including but not limited to carcass ply acting as a top layer that sustains load and absorbs shock subsequently, an inner liner acting as bottom layer to hold the air pressure inside the tire and an envelope that is sandwiched between said carcass ply and inner liner which at least covers the area proportionate to tread area from the inner side of the pneumatic tire.

In another embodiment, the present invention provides a pneumatic tire having a tread, a belt system and a tire casing. The tire casing is the body of the pneumatic tire comprises of a side wall, a bead and a plurality of layers such as but not limited to carcass ply, an inner liner and an envelope. The tire casing has plurality of layer including but not limited to carcass ply acting as a top layer that sustains load and absorbs shock subsequently, an inner liner acting as bottom layer to hold the air pressure inside the tire and an envelope that is sandwiched between said carcass ply and inner liner that covers the tread area and shoulder area from inner side of the pneumatic tire.

In another embodiment, the present invention provides a pneumatic tire having a tread, a belt system and a tire casing. The tire casing is the body of the pneumatic tire comprises of a side wall, a bead and a plurality of layers such as but not limited to carcass ply, an inner liner and an envelope. The tire casing has plurality of layer including but not limited to carcass ply acting as a top layer that sustains load and absorbs shock subsequently, an inner liner acting as bottom layer to hold the air pressure inside the tire and an envelope that is sandwiched between said carcass ply and inner liner that covers the tread area and shoulder area from inner side and part of side wall of the pneumatic tire and forms the bottom layer of the tire casing.

In yet another embodiment said semi viscous fluid in said envelope is having anti-freeze additives to keep it in fluid state even in sub-zero temperature; thereby working as a heat sink in cold winter and absorbing heat when running; and passing on the absorbed heat to other parts of said tire when soaking in cold. Said envelope being sandwiched between inner liner and other part of tire including carcass ply, fabric etc., the heat sink passes or absorbs the heat as the case may be from the fabric, carcass ply and tread area uniformly thereby maintaining near-uniformity of temperature in different parts of the tire.

The above objects and advantages of the present invention will become apparent from the hereinafter set forth brief description of the drawings, detailed description of the invention, and claims appended herewith.

### BRIEF DESCRIPTION OF THE DRAWINGS

An understanding of pneumatic tire with integrated envelope of the present invention may be obtained by reference to the following drawing:

FIG. 1 shows the structure of pneumatic tire in accordance with an embodiment of the present invention.

FIG. 2 shows the view of tire casing in accordance with an embodiment of the present invention.

FIG. 3 shows the perspective view of the tire casing having envelope that at least covers the area proportionate to tread area from the inner side of the pneumatic tire according to an embodiment of the present invention.

FIG. 4 shows the perspective view of the tire casing having envelope that covers the tread area and shoulder area from inner side of the pneumatic tire according to an embodiment of the present invention.

FIG. 5 shows the perspective view of the tire casing having envelope that covers the tread area and shoulder area from inner side and part of side wall of the pneumatic tire according to an embodiment of the present invention.

### DETAILED DESCRIPTION OF THE INVENTION

The present invention will now be described hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

The present invention provides a pneumatic tire accommodating an envelope with sealant and coolant to improve its strength, durability and life comprising of a tire casing having an envelope for encapsulating a sealant and coolant and also increasing the potency and verve of tire.

In an embodiment, the present invention provides a pneumatic tire with integrated envelope comprising, a tread, a belt system, and a tire casing, wherein, said tread is an outer layer of said pneumatic tire that comes in contact with a road surface, said tire casing comprises a side wall, a bead, a plurality of layer including but not limited to a carcass ply acting as a top layer, an inner liner acting as bottom layer and an envelope that is sandwiched between said carcass ply and the inner liner, said envelope is a closed hollow body that is injected with a fluid inside said tire casing in which said tire casing is pasted on said belt system and said belt system is pasted on said tread in said pneumatic tire, and said side wall protects said tire casing and said bead that wraps around the tire casing to connect said pneumatic tire to a rim of a wheel.

The pneumatic tire is manufactured without using a desired amount of talcum powder thereby preventing cracks and fixtures in said pneumatic tire and increasing life of said pneumatic tire. The envelope is sandwiched between said inner liner and said plurality of layer of said pneumatic tire. The envelope is pre-fabricated in said pneumatic tire. The envelope is semi-vulcanized and sandwiched between said plurality of layer and an inner surface of said inner liner. The envelope covers proportionately the tread area of said pneumatic tire. The envelope covers proportionately said tread area and a shoulder area from inner side of said pneumatic tire. The envelope covers proportionately said tread area and shoulder area from inner side part of side wall of said pneumatic tire. The envelope forming said middle layer is made of a material that includes but not limited to on butyl rubber and reclaim butyl and/or bromo butyl rubber. The envelope forming said middle layer is made of a material that includes butyl rubber and reclaim butyl and/or EPDM. The envelope forming said middle layer is made of a natural rubber and reclaim natural rubber and/or EPDM and/or neoprene rubber. The envelope forming said middle layer is made of a material that includes synthetic fibers like polyamides and/or nylon and/or dyneema and/or Kevlar and/or EPDM to encompass said fluid in said pneumatic tire. The envelope encompasses said fluid which includes but not limited to a semi viscous fluid which acts like a heat sink. The envelope is injected with a coolant to prevent overheating and/or localized overheating of the pneumatic tire. The envelop is having anti-freeze additives to keep it in fluid state even in sub-zero temperature. The envelope is injected with a sealant to seal any leakage in the pneumatic tire.

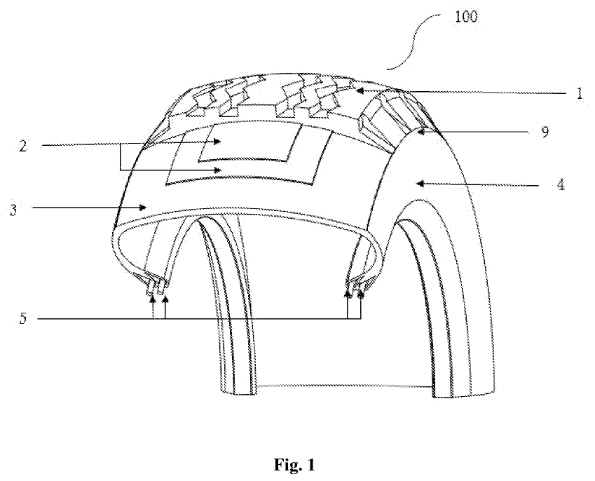

Now referring to FIG. 1, the present invention provides a structure of pneumatic tire (100) having a tread (1), a belt system (2) and a tire casing (3). The tread (1) is the outer layer of the tire (100) which forms the covering of said tire (100) that makes contact with the road or the ground. The tire casing (3) is the body of the tire (100) comprises of a side wall (4), a bead (5) and a plurality of layers such as but not limited to carcass ply (6), an inner liner (7) and an envelope (8). The tire casing (3) has plurality of layer including but not limited to carcass ply (6) acting as a top layer that sustains load and absorbs shock subsequently, an inner liner (7) acting as bottom layer to hold the air pressure inside the tire and an envelope (8) that is sandwiched between said carcass ply (6) and inner liner (7). The side wall (4) is the side part of the tire that protects the tire casing (3) and bead (5) wraps around the tire casing (3) that connects the tire to a rim of a wheel. Bead (5) is made of materials such as but not limited to rubber, elastomer. The envelope (8) is a closed hollow body injected with a sealant to seal any leakage in the tire. The envelope either touches the sidewall of the tire or is placed within the sidewall of the tire. The envelope (8) provided inside the tire casing (3) takes no load and is attached to the tire (100) and the pneumatic tire (100) is manufactured without using a desired amount of talcum powder thereby preventing cracks and fixtures and increasing life of said pneumatic tire (100). The tire casing (3) is pasted on the belt system (2) and said belt system (2) is pasted on the tread (1) and vulcanized together to form the structure of said tire (100). The belt system (2) provides strength and stability to the tread (1) and contributes to wear, handling and traction.

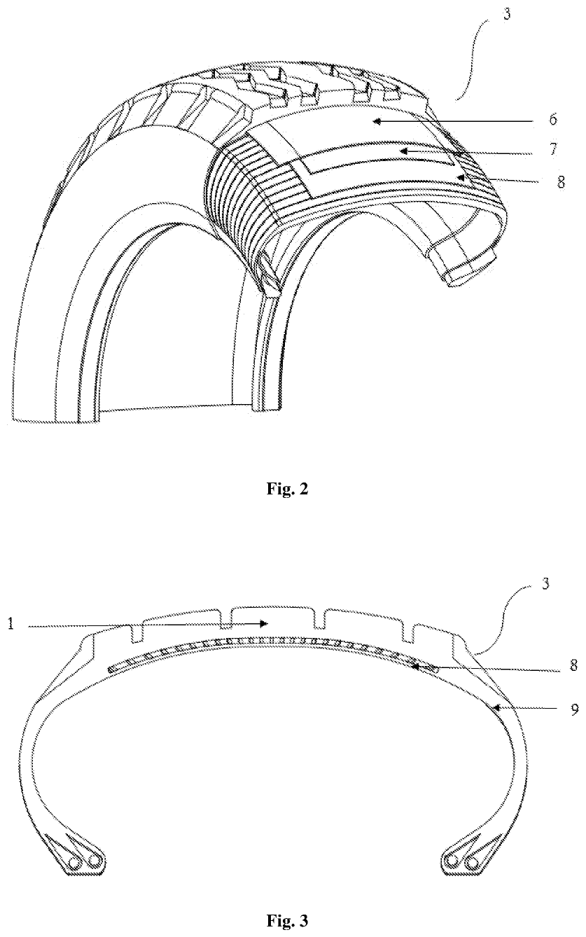

Now referring to FIG. 2, the present invention provides the view of tire casing (3). The tire casing (3) has plurality of layers wherein the top layer is a carcass ply (6) made of rubber that bears the load and provides the strength to the tire pasted on the belt system (2) subsequently, in one of the embodiment, the tire casing (3) has plurality of layer including but not limited to carcass ply (6) acting as a top layer that sustains load and absorbs shock subsequently, an inner liner (7) acting as bottom layer to hold the air pressure inside the tire and an envelope (8) that is sandwiched between said carcass ply (6) and inner liner (7) and is made of different materials. The material of the envelope is based on butyl rubber and reclaims butyl and/or bromo butyl rubber.

In another embodiment the material of the envelope is based on butyl rubber and reclaims butyl and/or EPDM. In yet another embodiment said material of the envelope is based on butyl rubber and reclaim butyl and/or EPDM and/or neoprene rubber. In another embodiment said material of the envelope is based on natural rubber and reclaims natural rubber and/or EPDM.

In another embodiment said material of the envelope is based on natural rubber and reclaims natural rubber and/or EPDM and/or neoprene rubber. In another embodiment said material of the envelope is multilayered synthetic fibers like polyamides, nylon, dyneema etc. The envelope is manufactured to contain sealant to seal the leakage in said tire in case of puncture and/or coolant to decrease localized over-heating.

The envelope (8) is pre-fabricated in said pneumatic tire (100) and envelope (8) is semi-vulcanized and sandwiched between said plurality of layer and an inner surface of said inner liner of said tire (100). The semi viscous fluid injected inside the envelope works like a heat sink maintaining temperature when vehicle soaks in cold at night in winter. The rubber compounds being brittle at low temperature said fluid inside the envelope works in maintaining temperature and thereby increasing life of the tire and averting tire failures.

The envelope (8) is a hollow body injected with a sealant and coolant. The level of pressure contained within the envelope (8) is controlled by injecting sealant so that if puncture arises, the sealant seeps through the envelope to seal the leakage in tire. The tire casing (3) is pasted on the belt system (2) and said belt system (2) is pasted on the tread (1) without any powder which provides an additional advantage of preventing cracks and fissures on pneumatic tire (100).

Now referring to FIG. 3, the present invention provides the perspective view of the of the tire casing having envelope that at least covers the area proportionate to tread area from the inner side of the pneumatic tire is depicted. The tire casing (3) has plurality of layers wherein the top layer is a carcass ply (6) made of rubber that bears the load and provides the strength to the tire pasted on the belt system (2) subsequently, in one of the embodiment, an inner liner (7) pasted to the carcass ply (6) to ensure the retention of air when tire is inflated followed by an envelope (8) that at least covers the area proportionate to tread (1) area from the inner side to contain a sealant to seal the leakage in said pneumatic tire (100).

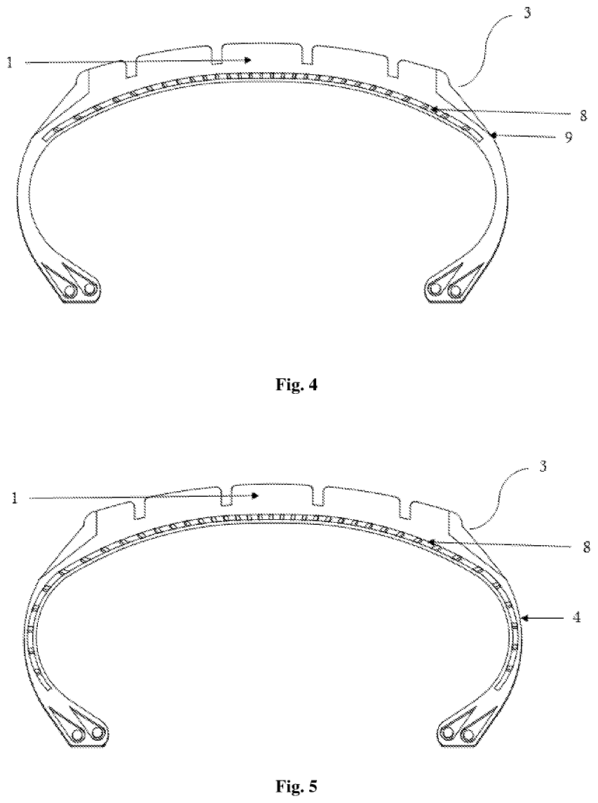

Now referring to FIG. 4, the present invention provides the perspective view of the tire casing having envelope that covers the tread area and shoulder area from inner side of the pneumatic tire is depicted. The tire casing (3) has plurality of layers wherein the top layer is a carcass ply (6) made of rubber that bears the load and provides the strength to the tire pasted on the belt system (2) subsequently, in one of the embodiment, an inner liner (7) pasted to the carcass ply (6) to ensure the retention of air when tire is inflated followed by an envelope (8) that covers the tread area and shoulder (9) area from inner side.

Now referring to FIG. 5, the perspective view of the tire casing having envelope that covers the tread area and shoulder area from inner side and part of side wall of the pneumatic tire is depicted. The tire casing (3) has plurality of layers wherein the top layer is a carcass ply (6) made of rubber that bears the load and provides the strength to the tire pasted on the belt system (2) subsequently, in one of the embodiment, an inner liner (7) pasted to the carcass ply (6) to ensure the retention of air when tire is inflated followed by an envelope (8) that covers the tread area and shoulder (9) area from inner side and part of the side wall (4).

Thus present invention provides the tire having an envelope sandwiched between inner liner and other elements of the tire that provides numerous advantages such as increase the life of tire by maintaining uniformity in temperature, pasted and vulcanized on the tread without the powder or any other separator at the time of assembly which prevents the crack and fissures in tire.

Many modifications and other embodiments of the invention set forth herein will readily occur to one skilled in the art to which the invention pertain having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

We claim:

1. A pneumatic tire (100) with integrated envelope comprising:
a tread (1);
a belt system (2); and
a tire casing (3);
wherein:
said tread (1) is an outer layer of said pneumatic tire (100) that comes in contact with a road surface;
said tire casing (3) comprises a side wall (4), a bead (5), a plurality of layer including but not limited to a carcass ply (6) acting as a top layer, an inner liner (7) acting as bottom layer and an envelope (8) that is sandwiched between said carcass ply (6) and the inner liner (7);
said envelope (8) is a closed hollow body that is injected with a fluid inside said tire casing (3) in which said tire casing (3) is pasted on said belt system (2) and said belt system (2) is pasted on said tread (1) in said pneumatic tire (100); and
said side wall (4) protects said tire casing (3) and said bead (5) that wraps around the tire casing (3) to connect said pneumatic tire (100) to a rim of a wheel.

2. The pneumatic tire (100) with integrated envelope as claimed in claim 1, wherein said pneumatic tire (100) is manufactured without using a desired amount of talcum powder thereby preventing cracks and fixtures in said pneumatic tire (100) and increasing life of said pneumatic tire (100).

3. The pneumatic tire (100) with integrated envelope as claimed in claim 1, wherein said envelope (8) is sandwiched between said inner liner and said plurality of layer of said pneumatic tire (100).

4. The pneumatic tire (100) with integrated envelope as claimed in claim 1, wherein said envelope (8) is pre-fabricated in said pneumatic tire (100).

5. The pneumatic tire (100) with integrated envelope as claimed in claim 1, wherein said envelope (8) is semi-vulcanized and sandwiched between said plurality of layer and an inner surface of said inner liner.

6. The pneumatic tire (100) with integrated envelope as claimed in claim 1, wherein said envelope (8) covers proportionately the tread area of said pneumatic tire (100).

7. The pneumatic tire (100) with integrated envelope as claimed in claim 1, wherein said envelope (8) covers proportionately said tread (1) area and a shoulder (9) area from inner side of said pneumatic tire (100).

8. The pneumatic tire (100) with integrated envelope as claimed in claim 1, wherein said envelope (8) covers proportionately said tread (1) area and shoulder (9) area from inner side part of side wall (4) of said pneumatic tire (100).

9. The pneumatic tire (100) with integrated envelope as claimed in claim 1, wherein said envelope (8) forming said middle layer is made of a material that includes but not limited to on butyl rubber and reclaim butyl and/or bromo butyl rubber.

10. The pneumatic tire (100) with integrated envelope as claimed in claim 1, wherein said envelope (8) forming said middle layer is made of a material that includes butyl rubber and reclaim butyl and/or EPDM.

11. The pneumatic tire (100) with integrated envelope as claimed in claim 1, wherein said envelope (8) forming said middle layer is made of a natural rubber and reclaim natural rubber and/or EPDM and/or neoprene rubber.

12. The pneumatic tire (100) with integrated envelope as claimed in claim 1, wherein said envelope (8) forming said middle layer is made of a material that includes synthetic fibers like polyamides and/or nylon and/or dyneema and/or Kevlar and/or EPDM to encompass said fluid in said pneumatic tire (100).

13. The pneumatic tire (100) with integrated envelope as claimed in claim 1, wherein said envelope (8) encompass said fluid which includes but not limited to a semi viscous fluid which acts like a heat sink.

14. The pneumatic tire (100) with integrated envelope as claimed in claim 1, wherein said envelope (8) is injected with a coolant to prevent overheating and/or localized overheating of the pneumatic tire (100).

15. The pneumatic tire (100) with integrated envelope as claimed in claim 1, wherein said envelope (8) is having anti-freeze additives to keep it in fluid state even in sub-zero temperature.

16. The pneumatic tire (100) with integrated envelope as claimed in claim 1, wherein said envelope (8) is injected with a sealant to seal any leakage in the pneumatic tire (100).
